(19) United States
(12) Patent Application Publication
(10) Pub. No.: US 2005/0066004 A1
(43) Pub. Date: Mar. 24, 2005

(54) Interactive real time visual conversation system for face-to-face communication

(76) Inventor: Kenneth A. Gan, Pittsford, NY (US)

Correspondence Address: Stephen B. Salai, Esq.;Harter, Secrest & Emery LLP, 1600 Bausch & Lomb Place, Rochester, NY, 14604-2711, US

(21) Appl. No.: 10/666,141

(22) Filed: Sep. 18, 2003

(51) Int. Cl. G06F 15/16

(52) U.S. Cl. 709/206

(57) ABSTRACT

An interactive real time visual face-to-face communication system provided with keyboard entry and associated display for each terminal. The terminals are configured to allow the display of pre-determined messages on a receiving terminal without corresponding display on the sending terminal, as well as allow for deletion of a conversation from either respective terminal.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to a system for providing communication without requiring audio aspects such as speech, and more particularly, to an aid for face-to-face communication, wherein text messages can be entered via a standard keyboard and displayed to both participants of a conversation without restricting non verbal communication.

2. Background Art

Historically, Deaf, Hard-of-Hearing and speech disabled persons have had a difficult time communicating with others who have not developed alternative communication skills. In fact, it is often more difficult to conduct a simple conversation between a person who is Deaf or speech disabled and a person without competency in an alternative communication skill such as American Sign Language (ASL). That is, if the message receiver has not been trained to understand ASL, then communication is typically laborious and error prone.

Prior technology for non-spoken communication between remote users has included use of a teletypewriter or TTY device. Such TTY device, also known as a telecommunication device for the deaf, or TDD, is connected to a telephone of the Deaf or Hard-of-Hearing person who communicates by typing onto a keyboard associated with a TDD and reading messages from the associated display. A TDD device must also be used by the person communicating with the Deaf or Hard-of-Hearing person. If a telephone with a TDD device is not available; a call can be completed by using a TDD relay service. For example, a conventional telephone user can call a TDD relay service, whereupon an operator uses a TDD to contact a TDD of the Deaf or Hard-of-Hearing person. Use of a human operator in such a relay service is known as a “voice carry over” (VCO). Similarly, a Deaf or Hard-of-Hearing person may use a TDD to call a telephone number, advertised by for example a business or government agency, to reach a TDD relay service which then contacts the business by conventional telephone.

However, the use of VCO requires a third person (the relay operator) in every telephone conversation, thereby compromising the privacy of the conversation as well as adding complications and costs. Alternatively, systems have been developed for use of the dual tone multi-frequency (DTMF) tones used by touch-tone telephones. In these systems, a decoder detects incoming sequences of DTMF tones sent by a standard touchtone telephone which is communication with the Deaf or Hard-of-Hearing person, and displays an alphanumeric character corresponding to each tone sequence on the display so that a message may be read. Messages are sent to the decoder one character (letter) at a time using a scheme in which a multiple key presses are used to distinguish between different letters associated with each key on the telephone keypad. For example, two presses of the “2” key in rapid succession are interpreted as the letter “B.”

While ASL has been developed for enhancing the communication abilities of Deaf, Hard-of-Hearing and speech disabled people, most hearing persons are not trained in ASL. The need exists for a face-to-face communication system that can provide real time interactive visual communication in conjunction with other visual cues such as body language or hand gestures. The need exists for such a communication system that employs standard interfaces and input schemes, without requiring additional training. The need further exists for a system that can be readily employed in any of a variety of environments having face to face communications, such as airport check-ins, auto sales, bank tellers, conference rooms, coffee shops, doctors offices, financial advisors and, insurance agencies. It is desirable to have an apparatus and method enabling communications between Deaf, Hard-of-Hearing and speech disabled persons and others, whether similarly situated or not. It is also desirable to have an apparatus and method for use by untrained hearing people so that they can effectively communicate with the Deaf, Hard-of-Hearing and speech disabled persons so as to enable a conversation. The present invention is directed toward overcoming the communication difficulties set forth above.

### BRIEF SUMMARY OF THE INVENTION

The present invention provides an interactive, real time face-to-face communication system for visual communication, in conjunction with additional non-verbal communication including gestures and facial expressions. The present system further provides an interactive communication system without requiring speech or specialized training, wherein face-to-face communication is supplemented by the present system.

The present invention allows cooperation between the participants in the conversation as the participants are sufficiently close so that each participant can distinguish gestures and the expressions on the face of the other. The present invention can be configured to require the participants be in a face-to-face orientation, or at least be within a visual line-of-sight of each other.

In one configuration, the communication system includes at least a first and a second terminal, each terminal having a keyboard and a display, wherein text messages are entered through a respective terminal keyboard and transmitted to the remaining terminal. The terminals can be configured to allow the deletion of a captured conversation from either terminal, as well as allowing one terminal to invoke a predetermined display on the second terminal without displaying the predetermined display on the first terminal.

In a further configuration, a separation distance between the terminals is sufficiently limited to maintain a face-to-face orientation of the participants. In addition, the present system supplements communication between face-to-face participants, thereby allowing simultaneous secondary non-verbal forms of communication. That is, the present system does not preclude simultaneous communication outside of the system. Thus, face-to-face communication between the non-signing hearing community and the deaf, heard of hearing and speech-disabled communities is facilitated.

### BRIEF DESCRIPTION OF THE SEVERAL VIEWS OF THE DRAWING(S)

FIG. 1 is a perspective view showing a first and second terminal operably interconnected for communication.

FIG. 2 is a schematic representation of at least a one terminal interconnected with a personal computer.

FIG. 3 is a flow chart of available operational functions.

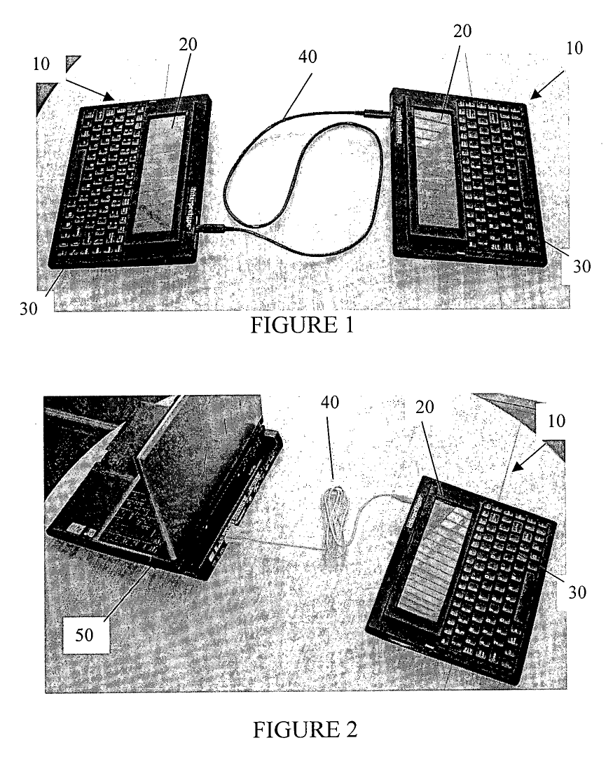

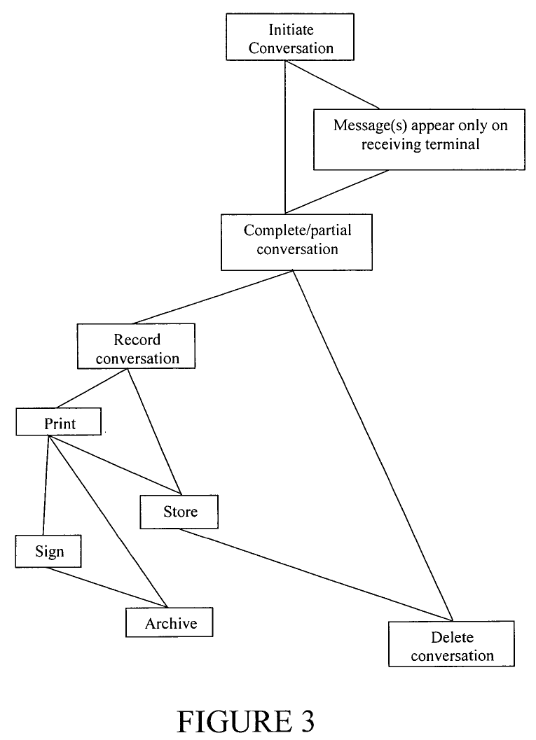

### DETAILED DESCRIPTION OF THE INVENTION

Referring to FIG. 1, the present invention includes an interconnected first and second terminals 10. For purposes of description, the terminals 10 will be designated as first and second terminals, or sending and receiving terminals, depending on the direction of communication. It is understood that each terminal 10 can be a sending terminal and receiving terminal depending upon the particular direction of communication.

Generally, the terminals 10 are configured to provide for the typing of text messages at the sending terminal, the transmission of the typed message to the receiving terminal, and the display of the transmitted message at the receiving terminal, wherein the receiving terminal can be used to enter a reply message, thereby providing a conversation between the operators.

Each terminal 10 includes a display 20 viewable by the respective user and a keyboard 30 for entering text messages. The display 20 is generally viewable only to the operator of the terminal 10. The display 20 can be any of a variety of constructions, including but not limited to LCD, dot matrix or CRT. The size of the display 20 is selected to, at least substantially; preclude interference with simultaneous face-to-face communication. Although the horizontal dimension of the display 20 can be any of a variety of sizes, the vertical dimension is selected to avoid interference with eye contact between the operators. A satisfactory display size is approximately 11 inches wide and 3 inches high.

Preferably, the keyboard 30 is a QWERTY configuration and full size to enable ready operation for all participants. Although reduced keyboard sizes are available, a preferred configuration of the system employs a standard size keyboard. Similarly, alternative keyboard configurations are possible, however it is preferable for the keyboard to be of standard layout. Thus, no additional training is required for either participant.

In addition, each terminal 10 includes a power supply as well as interfaces for interconnecting cabling 40 between the terminals, as well as to a personal computer. The power supply can be any of a variety of configurations including portable, rechargeable, disposable or plug in.

While it is understood the terminals 10 can be any of a variety of configurations, a satisfactory terminal includes the QuickPad Pro by QuickPad Technology Corporation of Mountain View, California. Typically, each terminal 10 also includes an on/off button, a reset button, a USB port, a serial port, an infrared port, a battery door and an external power connection.

In a preferred configuration, the terminals 10 are operably interconnected by cables 40 of a predetermined length. The cable lengths are selected to maintain face-to-face communication. Preferably, the cables 40 require the terminals to be within 3 to 12 feet of each other. While the cables 40 are a preferred means for interconnecting the terminals 10, it is understood that wireless communication between the terminals can be employed. In the wireless configuration, the wireless interconnection is selected to restrict the operating range of the terminals 10. That is, even though the terminals 10 may not be physically connected, the operable range is limited so that operators are required to be substantially face-to-face (within approximately 12 feet, and preferably within 4 feet).

The terminals 10 are programmed for controlled interaction, including the transmission, receipt and display of text messages. In one configuration, the transmission of text is line-by-line. Transmission of a particular line of text from the sending terminal 10 to the receiving terminal occurs either when a complete line of text is entered in the sending terminal, or the operator of the sending terminal commands transmission of a partially completed line of text, such as by employing the “enter” key on the sending terminal.

Further, the location of the text within the respective display 20 is predetermined. In one configuration, entered or received text initially appears near the bottom of the display 20 and is automatically scrolled upwards, in response to additional entered or received text. Thus, the most recent messages in the conversation appear near the bottom of the display 20 on each terminal 10. Selected keys are programmed to allow an operator to jump to the beginning or the end of the conversation, or scroll through the conversation in a line-by-line or screen-by-screen manner.

Further, each terminal 10 can be configured such that predetermined messages are associated with a given key or key sequence (a shortcut), thereby allowing reduced keystrokes for a given character string. The predetermined messages can be modified or entered by a given operator of the system. Typically, if the system is employed at a particular location for a given type of transaction, frequently occurring questions, answers or information can be entered into the terminal 10 for transmission in response to a given key stroke or sequence. Either one or both terminals 10 can be programmed with the same shortcuts. Alternatively, each terminal 10 can include a unique set of shortcuts, depending upon the intended uses. That is, if one terminal 10 is always used by a customer, typical customer questions, such as “When is delivery?” can be programmed into the customer terminal, while “How would you like to pay for that?” can be programmed into the service agent terminal 10. In one configuration, transmission of a shortcut text is a two step procedure. First, the desired shortcut is selected and displayed on the sending terminal 10. Then, the operator confirms and sends the message by, for example, using the “enter” key. It is understood, the message associated with a given short cut can be edited or modified at the sending terminal prior to transmission to the receiving terminal.

The terminals 10 can be programmed to provide that the initiation of the conversation begins with each user entering a respective user name. The terminals 10 are programmed to confirm logon of the user, and the user name. Upon each user logging on (entering a user name) the system is initiated. Each terminal 10 then associates each message with the user name that entered and transmitted the associated message. In addition, or alternatively, each terminal 10 can automatically provide an indicator of the sender (or originator) of each line of text. For example, each message can automatically include an associated indicator identifying the sender. Such identifier can either be a carrot (<, >), or alternatively may be the entered user name. For example, “<” indicates a message sent to the other terminal. The arrow prints away from the screen text. “→” Indicates messages received from the other terminal 10. The arrow prints to the screen text.

Each terminal 10 allows for the transmission of a predetermined message to the receiving terminal, without the predetermined message appearing on the display 20 of the sending terminal. For example, a selected key of the keyboard 30 can be associated with a “Go ahead” command such that upon pressing the respective key on the sending terminal, “Go ahead” appears on the receiving terminal, without appearing on the sending terminal. As the “Go ahead” command does not appear on the sending terminal, the wording cannot be modified.

It is further understood the “Go ahead” command can be employed in conjunction with the previously entered user name, such that the message displayed at the receiving terminal but not at the sending terminal is “Go ahead Ken, its your turn.”

It is understood that any of a variety of predetermined messages can be represented by shortcuts, wherein the predetermined messages are displayed only upon the receiving the terminal 10. That is, a plurality of conversational prompts, such as “Thank You” or “Hello” can be sent to the receiving terminal, without appearing at the sending terminal. However, in those configurations of the system for recording conversations, it is advantageous to limit the number of messages appearing on just a single screen. Thus, typically those messages appearing on just a single display are limited to conversation facilitators, rather than substantive aspects of the conversation. In a preferred configuration only the “Go Ahead” term which is pre-programmed in the software can be sent without viewing on the first (sending) terminal, and thus the “Go Ahead” term cannot be modified. In certain configurations, the “Go Ahead” term is the only instance in which the software will forward a message without display or editing on the sending terminal. The function keys allow for nine choices of messages that can be edited, wherein the messages will always appear on the sending terminal before being sent to the receiving terminal.

Each terminal 10 also allows for the deletion of inputted text before being sent to the second terminal. This can be accomplished in several ways. Use of the Backspace and Delete keys will remove one character at a time and the Left Arrow key will remove an entire line of text before it is sent to the second terminal. These features can be used for typed text or if a predetermined message is selected in error.

Each terminal 10 has an adjustable font size feature that allows the user to toggle the font between normal size and double size. This can be accomplished through keyboard commands that do not affect the conversation.

Each terminal 10 has an adjustable contrast feature that allows the user to adjust the contrast of the characters on the viewing screen. This can be accomplished through keyboard commands that do not affect the conversation.

In a further configuration, each terminal 10 is programmed to allow for the deletion of an entire conversation from both terminals. That is, a command to delete the conversation can be initiated at either terminal 10 and upon confirmation [at the initiating terminal or either terminal,] the entire conversation can be deleted from both terminals. This feature allows either participant to maintain a degree of confidentiality of the conversation. This confidentiality is particularly advantageous for use of the system in medical offices, financial institutions and other conversations encompassing private or privileged information. Typically, a conversation will include alternating messages from each terminal. The length of each message does not impact the conversation. The terminals 10 are programmed so that an entire conversation can be deleted; yet the user can continue the conversation, such that only the continued conversation is available for capture and printing.

It is also contemplated that a personal computer 50 can be programmed as respective sending/receiving terminal, wherein the increased memory capabilities and typical associated printer can be employed for preparing hardcopies of any conversation. The necessary programming can be embodied in a machine readable format, such as a CD or DVD for installation onto the computer 50. It is also contemplated that the software can be downloaded from a computer network onto the respective computer 50. Preferably, the computer 50 is thus programmed in accordance with the presently described functionality of the terminals 10. The computer 50 can be configured as a terminal 10 for use in the present system. Alternatively, the computer 50 can be employed as merely a storage device and interface to an existing printer.

A benefit of employing a computer 50 as a terminal 10 (or interface) is that conversations can be stored and/or provided in hard copy for record keeping.

Conversations can be saved in a number of manners. If one of the terminals 10 is connected to the personal computer 50, or the personal computer is functioning as a terminal, the entire conversation can be sent to and stored on the computer 50. Such conversations can be saved as a file on the computer and can be subsequently printed, archived, reviewed, edited or e-mailed.

For conversations between terminals 10 without any computer 50 connected, prior to deleting the conversation, the computer is connected to one of the terminals and the file is transferred to the computer to be saved by the computer.

Similarly, the conversation can be printed. Specifically, if the computer 50 is operably connected during the conversation, or is functioning as one of the terminals, the “print file” command can be executed on either the terminal 10 or the computer.

If the conversation occurred with the system consisting of the terminal 10, the computer 50 is connected to one of the terminals prior to deleting the conversation. The “print conversation” command can then be executed at the connected terminal 10 or the computer 50 to print the conversation.

Preferably, the computer 50 can be removed from connection with the terminal 10, and the conversation continued between the terminals.

For example, upon the completion of a conversation, which can include an agreement of terms or understanding of future actions, the conversation can be automatically printed, via the personal computer 50 and associated printer. The present programming provides that the resulting printed conversation includes two signature lines and date stamp. The signature lines and date stamp are provided at the end of the conversation. Alternatively, an initial line with date stamp can be provided on all but the end page, wherein the end page includes the full signature line. It is also contemplated that the printed conversation will be page labeled by “page ______ of ______,” so that there is no uncertainty of the length. This allows for both participants of the conversation to obtain and retain a hard copy of the conversation, and any included terms.

It is further contemplated the terminals 10 can be configured with language translation software or programs such as Systran from Systran Information, Translation Services SA, EasyTranslator, Translate Express, or Word Magic. Such programs allow the entering of the text in a given language and upon the operator selecting the desired translation, will display the translated message at the receiving terminal. It is anticipated the previously recited features can all be used in coordination with the translation feature. Thus, the present system can be employed at sites typically associated with multilingual communication such as airports, train stations and bus depots as well as population members for whom English is not the primary language. The system can also incorporate non-English keyboards with English keyboards or any combination thereof to facilitate communication between many different languages.

While a preferred embodiment of the invention has been shown and described with particularity, it will be appreciated that various changes and modifications may suggest themselves to one having ordinary skill in the art upon being apprised of the present invention. It is intended to encompass all such changes and modifications as fall within the scope and spirit of the appended claims.

1. A communication system for providing face-to-face interactive real time text messaging, the system comprising:
(a) a first and a second terminal, each terminal having a keyboard for entering text and a display for displaying entered and received text, each terminal configured to transmit and receive text from the other terminal, the first terminal configured to delete text received and displayed by the second terminal; and
(b) a communication link between the first terminal and the second terminal, the communication link configured to enable communication between the first and the second terminal in a face to face position and preclude communication beyond a face to face position.

2. The communication system of claim 1, wherein the first and the second terminals are configured to precede each displayed line of text with an identifier of the sending terminal.

3. The communication system of claim 1, wherein the communication link includes a cable having a length to place the first and second terminals in the face-to-face position.

4. A method providing two way interactive text messaging, the method comprising:
(a) locating a first and a second terminal in a face to face position;
(b) keying text into the first terminal;
(c) displaying the keyed text at the first terminal;
(d) transmitting the displayed text from the first terminal to the second terminal;
(e) displaying the transmitted text at the second terminal in conjunction with a first terminal identifier; and
(f) deleting displayed text at the second terminal in response to a command from the first terminal.

5. A method providing two way interactive text messaging, the method comprising:
(a) locating a first and a second terminal in a face to face position;
(b) selecting one of a first set of predefined messages in the first terminal by a first associated shortcut key;
(c) displaying the selected text at the first terminal;
(d) transmitting the displayed text from the first terminal to the second terminal;
(e) displaying the transmitted text at the second terminal in conjunction with a first terminal identifier; and
(f) selecting one of a different second set of predefined messages in the second terminal by a second associated shortcut key.

6. The method of claim 5, further comprising editing the selected message at the first terminal prior to transmitting to the second terminal.

7. The method of claim 5, further comprising deleting, in response to a command from the first terminal, all previously transmitted and received messages between the first and the second terminal.

8. The method of claim 5, further comprising printing the previously transmitted and received messages between the first and the second terminal to include a signature line.

9. The method of claim 5, further comprising displaying a predetermined message from the first terminal only on the second terminal in response to a command at the first terminal.

10. A face-to-face text communication system comprising:
(a) a first terminal having a first keyboard and a first display;
(b) a second terminal having a second keyboard and a second display, both the first terminal and the second terminal configured to transmit and receive text from and to each other, the first terminal configured to invoke a predetermined display on the second terminal without displaying the predetermined display on the first terminal.

11. The communication system of claim 10, wherein one the first terminal and the second terminal is configured to delete text received at the remaining terminal.

12. A face-to-face text communication system comprising:
(a) a first terminal having a first keyboard and a first display;
(b) a computer having a second keyboard and a second display, both the first terminal and the computer configured to transmit and receive text from and to each other, the first terminal configured to invoke a predetermined display on the computer without displaying the predetermined display on the first terminal.

13. The communication system of claim 12, wherein one the first terminal and the computer is configured to delete text received at the remaining terminal.

14. A communication system for providing face-to-face interactive real time text messaging, the system comprising:
(a) a first and a second terminal, each terminal having a keyboard for entering text and a display for displaying entered and received text, each terminal configured to transmit and receive text from the other terminal, each terminal including translating programming for translating entered text from a first language to a different second language; and
(b) a communication link between the first terminal and the second terminal, the communication link configured to enable communication between the first and the second terminal in a face to face position and preclude communication beyond a face to face position.

15. The communication system of claim 14, wherein the first terminal is configured to display a predetermined message on the second terminal without displaying the predetermined message on the first terminal.
